(19) United States
(12) Patent Application Publication
(10) Pub. No.: US 2015/0052603 A1
(43) Pub. Date: Feb. 19, 2015

(54) ANTI-TAMPER SYSTEM WITH SELF-ADJUSTING GUARDS

(71) Applicant: Arxan Technologies, Inc., Bethesda, MD (US)

(72) Inventor: Kevin Dale Morgan, San Francisco, CA (US)

(73) Assignee: Arxan Technologies, Inc., Bethesda, MD (US)

(21) Appl. No.: 13/965,727

(22) Filed: Aug. 13, 2013

(51) Int. Cl. H04L 29/06

(52) U.S. Cl. CPC H04L 63/14
USPC 726/22

(57) ABSTRACT

An anti-tamper system is disclosed that includes self-adjusting guards inserted in software. Self-adjusting guards include invocation criteria and guard function. During run-time, each time the self-adjusting guard is invoked, the invocation criteria is evaluated and the guard function is only executed if the invocation criteria is satisfied. The invocation criteria can be static or dynamic, satisfied randomly with fixed or varying probability, a monotonically or exponentially decreasing function or most any other type of function. The invocation criteria can be satisfied based on elapsed inter-guard invocation time (time since last guard function execution), target inter-guard invocation time, and/or guard execution time. A method is disclosed of inserting self-adjusting guards into software, and executing the software. Evaluating the invocation criteria can include adjusting the invocation criteria when satisfied. The self-adjusting guards can be inserted into the software at a source or object code level.

### BACKGROUND

The present invention relates to anti-tamper and anti-reverse engineering solutions for software, particularly anti-tamper and anti-reverse engineering solutions that utilize internal in-line operations embedded directly in the software being protected which provide anti-tamper and anti-reverse engineering services when executed.

Computer software is increasingly the basis for human social and business interactions. The economy of the world is increasingly predicated on the reliable operation of software. Critical software operation is no longer confined to company or household internal environments, but is increasingly deployed on mobile computing environments which are subject to loss and/or theft.

In our increasingly software dependent society, the need for software which protects itself from misuse through tampering, and from successful tampering through reverse engineering, is required. The injection of units of protection software (“guards”) into software to perform anti-tamper and anti-reverse engineering operations has a long history of invention and commercial development and deployment (see, for example, “Method and System for Tamperproofing Software,” U.S. Pat. No. 7,757,097, and “New Guards for Application in Software Tamperproofing,” U.S. Pat. No. 7,287,166).

Specific guard types vary widely, each serving different protection needs. Code tampering can be addressed with checksum guards. Debugger usage against the program can be addressed with anti-debug guards. Code hiding can be addressed with pre-damage guards, where, for example, the targeted code is replaced with incorrect code and a code correction guard is placed immediately prior to invocation of the incorrect code. Encryption guards are a specific style of code hiding guard, utilizing decryption techniques to reveal and put into place during run-time the correct code at the correct memory locations. Value verification guards can check the correctness of specific data values and perform overt or subtle damage operations on the program state to compromise the proper execution of the software when incorrect data values are identified. Many other guard types are possible and have been developed and deployed.

Code obfuscation is a protection mechanism that does not utilize a protection unit of software (a guard providing an anti-tamper function placed into the program code), but rather changes the structure of the software to make automated and human analysis (“reverse engineering”) of its operation more difficult.

Guards are incremental software units placed into the software to be protected. The software is protected through the execution of the guards during the software run-time. As a result, software protection using this type of internal guarding methodology can have a negative performance impact and cause a longer run-time for the protected software.

For this reason, a common method of guard insertion is through targeted placement. In this methodology, the areas of specific concern regarding reverse engineering and/or tampering are explicitly identified through a primarily human executed process (a “threat analysis”). Locations for guard placement are identified that balance the need for guard execution and the timeliness of guard execution relative to the area to be protected by that guard. A specification of guard placement is produced as a human executed design process, possibly utilizing program execution flow and program timing information captured through the use of tools commonly used by those with skill in the art. An exemplary process of human guard network design driven by threat analysis is illustrated in the guard insertion process 100 of FIG. 1.

The process 100 illustrated in FIG. 1 starts with software source code 102 and a software functional description 104. Human analysis of these inputs results in a software threat analysis 106 resulting in threat descriptions 108 which can include threat descriptions and at risk code identifications. The threat descriptions 108 along with the source code 102 and the software functional description 104 are analyzed by humans to develop a protection design 110 and a guard network specification 112. The protection design 110 can include guard network structure, targets and placements. The source code 102 goes through a compilation and linking process 114 that produces binary code 116 that can include build artifacts. An automated guard insertion process 120 can take the source code 102, binary code 116 and guard network specification 112 to generate guard protected software 122. The guard protected software 122 can be in source or binary form. The guard protected software 122 can go through a tuning process 124 where measurements and tuning is done using guard protection design adjustments. The tuning process 124 can be part of an iterative process to provide further input to develop the protection design 110 and the guard network specification 112, resulting in a revised guard insertion process 120 generating revised guard protected software 122. The final as well as intermediate guard protected software 122 can be delivered 130.

An alternative guard insertion method is to use program execution profiling information to aid in the identification of best-fit locations for guard insertion (see for example “An Anti-Tamper System Employing Automated Analysis”, Int'l Pub. WO 2009/125220 A1). The objective of such a method is to use the profiling information to guide the placement of guards to balance the need for occasional guard execution with the need for minimal overall performance impact. Typically the initial guard placement from such an automated process needs a round of impact measurement, followed by human executed tuning to complete the overall balanced guard insertion design. An exemplary process of automated guard protection design driven by profiling information is illustrated in the guard insertion process 200 shown in FIG. 2.

The process 200 illustrated in FIG. 2 also starts with software source code 202 and a software functional description 204. Automated analysis of these inputs results in a software profiling process 206 generates profile data 208. The profile data 208 along with the source code 202 and the software functional description 204 are analyzed in an automated protection design process 210 to produce a guard network specification 212. The protection design 210 can include guard network structure, targets and placements. The source code 202 goes through a compilation and linking process 214 that produces binary code 216 that can include build artifacts. An automated guard insertion process 220 can take the source code 202, binary code 216 and guard network specification 212 to generate guard protected software 222. The guard protected software 222 can be in source or binary form. The guard protected software 222 can go through a tuning process 224 where measurements and tuning are done using guard protection design adjustments. The tuning process 224 can be part of an iterative process to provide further input to develop the protection design 210 and the guard network specification 212, resulting in a revised guard insertion process 220 generating revised guard protected software 222. The final as well as intermediate guard protected software 222 can be delivered 230.

A third guard insertion method is using non-targeted automation. In such a method, no a priori knowledge of the run-time behavior of the software to be protected is used by an automated guard injection system. The automation system uses a direct review of the executable code (in a static manner, not through observation of the software under execution) to identify locations in the code for insertion of guards of a variety of types. Through the static analysis process, thoroughness of coverage in terms of different possible paths of execution and hence needs for multiple guards in multiple locations, possibly with overlapped functioning (i.e., overlapped ranges of checksum guards), can be addressed. Overall coverage in terms of code and/or data memory areas to be protected (for example checksumming of code area to detect code tampering) can be addressed through allocation of different blocks of memory to be checked by different guards, with the sum total being “all” of the overall memory space.

The challenge with this third type of automated guard insertion method using no a priori information on run-time behavior of the software while striving to provide comprehensive tampering protection coverage over all critical elements of an application is the risk of negative performance impact. When using only knowledge available from a static (non-running) assessment of the code by the automated insertion tool, it is possible and even likely that significant guard functions will be inserted into highly performance sensitive areas of the application code.

Guard placement and execution problems have historically been addressed through two fundamental methods. The first method is through targeted placement of the guards, and targeted area and/or times of operation of the guards. This targeted placement is based on external analysis and specification typically executed by humans. The second method is through the control or influence of run-time profiling data of the software to be protected.

It would be desirable to have a system that addresses the need for low cost and low overhead automated insertion of guards combined with a means of managing the impact of guard performance on the execution of the protected program including repeated execution due to program looping.

### SUMMARY

An anti-tamper system is disclosed for protected software on a computer having a processor and a memory, where the anti-tamper system includes a self-adjusting guard inserted in the protected software. The protected software and the self-adjusting guard are stored in the memory of the computer. The self-adjusting guard includes an invocation criteria and a guard function, the guard function providing some anti-tamper protection for the protected software. During run-time of the protected software by the processor of the computer, each time the processor invokes the self-adjusting guard, the processor first evaluates the invocation criteria of the self-adjusting guard, and then executes the guard function if the invocation criteria is satisfied and does not execute the guard function if the invocation criteria is not satisfied.

The invocation criteria of the self-adjusting guard can be configured so it is only satisfied during the Nth time the processor invokes the self-adjusting guard. Alternatively, the invocation criteria can maintain a count of each time the processor invokes the invocation criteria during run-time of the protected software, and the invocation criteria can be satisfied during the Mth time the processor invokes the invocation criteria and every Nth time thereafter. The invocation criteria can be satisfied randomly with a fixed probability of being satisfied. The invocation criteria can maintain a count of each time the processor invokes the invocation criteria during run-time of the protected software, and the invocation criteria can be satisfied based on an exponentially decreasing function.

The invocation criteria of the self-adjusting guard can include a target probability of guard function execution that is stored in the memory of the computer, a random or pseudo-random number generator, and an invocation range. The random number generator can generate a random value in a generation range each time the processor invokes the invocation criteria during run-time of the protected software. The invocation range can be a subset of the generation range and the probability of the random value being in the invocation range can be equal to the target probability of guard function execution. The invocation criteria can be satisfied when the random value is in the invocation range, and upon being satisfied the target probability can be decreased and the invocation range reduced accordingly.

The invocation criteria of the self-adjusting guard can be satisfied based on an elapsed inter-guard invocation time measuring a time duration since that last time the guard function of the self-adjusting guard was executed. The invocation criteria of the self-adjusting guard can also maintain a target inter-guard invocation time indicating the minimum time duration before execution of the guard function, and the guard function can be satisfied when the elapsed inter-guard invocation time is greater than the target inter-guard invocation time. The target inter-guard invocation time can be increased after each execution of the guard function of the self-adjusting guard.

The invocation criteria can be satisfied based on the elapsed inter-guard invocation time and a guard execution time measuring the time duration for executing the guard function of the self-adjusting guard. The invocation criteria can be satisfied when a ratio of the guard execution time to the elapsed inter-guard invocation time is less than a threshold ratio. The threshold ratio can be decreased after each execution of the guard function of the self-adjusting guard.

A method is disclosed for protecting software on a computer having a processor and a memory. The method includes inserting a self-adjusting guard into the software to generate protected software, and executing the protected software on the computer. The protected software and the self-adjusting guard are stored in the memory of the computer. The self-adjusting guard includes an invocation criteria and a guard function, where the guard function provides some anti-tamper protection for the protected software. Each time the processor of the computer invokes the self-adjusting guard, the method includes evaluating the invocation criteria of the self-adjusting guard, executing the guard function if the invocation criteria is satisfied, and not executing the guard function if the invocation criteria is not satisfied. Evaluating the invocation criteria of the self-adjusting guard can include evaluating the invocation criteria, and adjusting the invocation criteria if the invocation criteria is satisfied. Adjusting the invocation criteria can include decreasing the likelihood of satisfying the invocation criteria, or updating a target value for satisfying the invocation criteria. Updating a target value for satisfying the invocation criteria can include decreasing a probability of satisfaction of the invocation criteria, or computing new minimum time duration until execution of the guard function.

Inserting a self-adjusting guard into the software to generate protected software can include inserting source code for the self-adjusting guard into source code for the software to generate source code for the protected software. Inserting a self-adjusting guard into the software to generate protected software can include inserting object code for the self-adjusting guard into object code for the software to generate object code for the protected software.

### BRIEF DESCRIPTION OF THE DRAWINGS

FIG. 1 illustrates a guard insertion method of human guard network design driven by threat analysis;

FIG. 2 illustrates a guard insertion method of automated guard protection design driven by profile data;

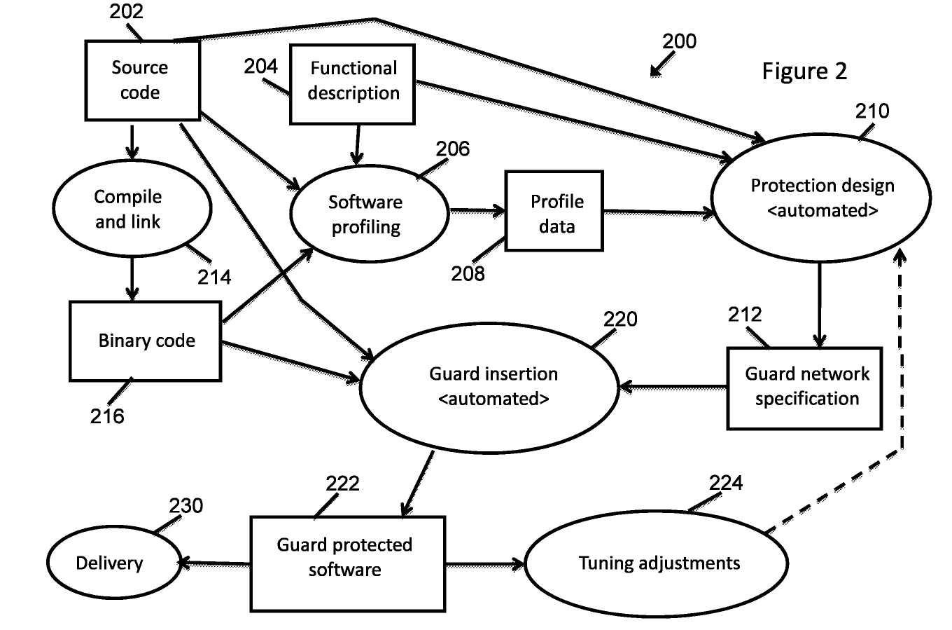

FIG. 3 illustrates a guard insertion method using self-adjusting guards; and

FIG. 4 illustrates an exemplary computer system capable of performing a guard insertion method.

### DESCRIPTION OF EXEMPLARY EMBODIMENTS

For the purposes of promoting an understanding of the principles of the novel technology, reference will now be made to the exemplary embodiments described herein and illustrated in the drawings and specific language will be used to describe the same. It will nevertheless be understood that no limitation of the scope of the novel technology is thereby intended, such alterations and further modifications in the illustrated devices and methods, and such further applications of the principles of the novel technology as illustrated therein being contemplated as would normally occur to one skilled in the art to which the novel technology relates.

A computer implemented anti-tamper system is disclosed in which units of integrity protecting software (“guards”) are inserted into the software to be protected using automated or manual methods without requiring a-priori knowledge of program behavior or data regarding program behavior. Each guard can protect specific areas of code, and protect against specific tampering and/or reverse engineering operations. Each guard can perform self-monitoring of invocation frequency, and adjust its guard service execution dynamically to balance the protection service of the guard relative to the performance impact of guard operation.

A system is disclosed that can manage the performance impact of guard execution, regardless of the specific method utilized for guard placement. Guard placement can be automated (using any number of techniques to assure comprehensive coverage of the software to be protected by the overall guard set inserted), or can be “manual” meaning the specifics are ultimately based on human decision making (similar to general software program development). The system can account for the specifics of guard function execution in making the decision whether to execute the guard function or not. Guard function execution can be managed within the guards themselves. The frequency of execution of the functional elements of every guard can be dynamically adjusted by each guard itself based on various parameters, for example, based on prior individual guard execution history, and/or based on global execution time measurements of the entire software program, and/or based on global guard execution frequencies. The dynamic behavior property added to the guards can restrict or incrementally reduce the frequency of execution of the guard function.

Guards can be enhanced with dynamic behavioral properties to dynamically adjust their frequency of execution to provide a balance between the need for guard function execution (to provide the integrity checking anti-tampering and anti-reversing value) with the need for minimizing the performance impact on the protected software. Such guards can be utilized in any or all of the various guard insertion methods disclosed, or in new and unique insertion methods. The self-adjusting guards can be injected into the software to be protected at the source code, object code, byte code and/or machine binary code levels.

When guards are inserted into code not executed in a loop, or in a function that is called only once in the overall execution lifecycle of the software, guard execution frequency adjustment is not required.

When a guard is executed in a loop or in a function called repetitively, repeated execution of the guard function is not typically required from the perspective of the integrity checking service. An internal guarding design approach to assure application integrity by definition and design has discrete points in time where integrity checks are being performed during the execution of the program. Extremely rapid and repeated guard execution has additional integrity checking value, but at the same time can be excessive. Repeated execution of guard functions over time can be of value if there are dynamic attack events occurring on the software (changes in code, inappropriate changes in data, debugging activity, or similar). It is a design decision and tradeoff as to how frequently guards should be invoked.

A trade-off approach balancing integrity checking with performance impacts can be used in which the guards execute their core integrity function (guard function execution) not each and every time the program execution flow reaches the inserted guard (guard invocation). There are a wide variety of alternatives to this “not every time” approach, and it can be extended so that guard function execution happens “less and less frequently” the more times the guard is invoked.

Each guard can track the frequency of its own invocation and execution. A back-off algorithm can reduce the frequency of execution of the guard function (for example, the execution of the actual checksum operation of a checksum guard). A standard guard performs some guard function, for example checksum, anti-debug, repair code or data, etc. A self-adjusting guard first checks the frequency of invocation, and then performs its guard function if the invocation frequency is acceptable.

A back-off or adjustment algorithm for a self-adjusting guard can be of a range of types. At the most extreme, the adjustment algorithm can be a simple “perform the guard function once, and never again.” In a variation of this back-off algorithm, the guard function can be executed only once on the Nth invocation. An exemplary adjusting algorithm for this is:

Specify an execution invocation count N;
Given global counter X, with X initialized to zero;
On guard invocation:

X++
If X==N, then execute the guard function

Another simple back-off algorithm example that can be used to execute the guard function can include every Nth invocation, or every Nth invocation starting with the Mth invocation. An exemplary adjusting algorithm for this is:

Specify an execution invocation initial count N, and frequency repeater M;
Given global counter X, with X initialized to zero;
On guard invocation:

X++
If((abs(X−N)) modulo M) == 0, then execute the guard function

Other simple back-off algorithm examples that can be used to execute the guard function can include randomly with a fixed probability, every 2̂N invocations, randomly with a decaying probability of invocation after each invocation, etc.

Randomized execution of guard functions is another form of “not every time” guard function invocation. The back-off or adjustment algorithm can execute the guard function on a random or pseudo-random basis using a fixed probability of guard function execution (for example, “on a pseudo-random basis execute the guard function 5% of the time that the guard is invoked”). A simple approach is to use a fixed probability of execution P. When invoked, a guard computes a random or pseudo-random number in a range, and computes if that random value is in a subset of the range that maps to the probability P. Typically P is expressed as a real number between 0 and 1 (exclusive), and the random number is generated in this same range. If the random number is between 0 and P, the guard function can be executed, and if not the guard function can be skipped. An exemplary adjusting algorithm for this is:

Specify a probability of execution P, where 0<P<1;
Generate a random or pseudo-random number, x, between 0 and 1;
If x < P, then execute the guard function

The above methods for “not every time” guard function execution use static (or static probability) methods for separating guard function execution events. More dynamic approaches can be used for guard function execution decision algorithms that increase/decrease the frequency of guard function execution, relative to guard invocation. The power of this technique and use of self-adjusting guards can increase with more dynamic back-off or adjustment algorithms, in which the frequency of guard function execution decreases after some or every guard function execution.

For example, a simple and low overhead approach is to use an exponential back-off algorithm based on powers of two, which can be implemented by merely shifting a single bit in a memory location to mark the next count value for which the guard should be fully executed. For example, initially a guard invocation count is “0” and a target count value can be set to “1”. On initial invocation, the invocation count is incremented from “0” to “1,” and since the invocation count is equal to the target count, the guard function is executed and the target count value bit is shifted by one, giving a target count of “2.” On the second invocation of the guard, the invocation count is incremented from “1” to “2,” and again the guard function is executed and the target count value bit is shifted by one, giving a target count of “4.” On the third invocation, the invocation count is incremented from “2” to “3,” and since the invocation count is not equal to the target count, the guard function is skipped. But on the fourth invocation, the invocation count is incremented from “3” to “4,” and since the invocation count is equal to the target count, the guard function is executed and the target count value bit is shifted by one, giving a target count of “8.” The guard function continues execution on the 8^{th}, 16^{th}, 32^{nd}, etc. invocation, effecting an exponential guard function execution “back-off” algorithm, driven by the frequency of invocation of the guard.

Other examples of adjustment algorithms with decreasing frequency of execution that may be deployed are described below. The adjustment algorithm for a self-adjusting guard can use one or more of these exemplary algorithms and other algorithms to control triggering of execution of the guard function.

An adjustment algorithm can use a function F(Y) for which:

(F(Y+1)−F(Y))<(F(Y+2)−F(Y+1)) for all Y.

An exemplary adjustment algorithm using this function can include:

Given global counters X and Y, with X and Y are initialized to zero;
On guard invocation:

X++;
If X = F(Y), then execute guard function and Y++.

This exemplary adjustment algorithm can also be based on real-time measurements.

A monotonically decreasing adjustment algorithm can be used to control the frequency of guard function execution. An exponential back-off algorithm using any desired base value can be used. For example, execution of the guard function can occur on the 1^{st}, 10^{th}, 100^{th}, 1000^{th}, etc. invocation of the guard. Any monotonically decreasing function may be used in place of an exponentially decreasing function.

The adjustment algorithm can vary the back-off using pseudo random execution with a changing probability. For example, the adjustment algorithm can pseudo randomly decide to execute the guard function with a probability of 10% and to reduce the guard function probability by a factor of ten each time the guard function is executed. In this case the first execution probability of the guard function is 10%, the second execution probability is 1%, the third execution probability is 0.1%, the fourth execution probability is 0.01%, etc. As another example, the probability of guard function execution can initially be set at 10% and the guard function probability can be reduced by 50% each time the guard function is executed. In this case the first execution probability of the guard function is 10%, the second execution probability is 5%, the third execution probability is 2.5%, the fourth execution probability is 1.25%, etc.

As an example implementation, an adjustment algorithm can use an initial probability of execution P, where 0<P<1, and the implementation can include:

Given global counter Y initialized to zero;
Given function F(P) where 1> P > F(P) >0;
Generate a random or pseudo-random number, x, between 0 and 1;
P = F(P);
If x < P, then execute the guard function.

The above algorithms have been based on some form of counting guard invocations. However, the adjustment algorithm can utilize real-time measurements of the guard invocation or execution, and other program execution timing measurements. Real-time clock measurements can be substituted as a means for measuring the time between guard invocations and executions, and the above methods may be applied using real-time clocks instead of invocation counts. One example of such an algorithm is to execute the guard function and start a real-time clock measurement on the first invocation. On the second guard invocation, the elapsed time (inter-guard invocation time) is captured, and the guard function is (optionally) again executed. The inter-guard invocation time is doubled, and is stored as a minimum time threshold until the next guard function execution. Successive invocations of the guard capture the cumulative time since the last guard function execution, and the guard function is again executed only when this cumulative real-time has exceeded the saved minimum time threshold. Once executed, the new elapsed time is doubled and stored as a new minimum time threshold, and the cumulative time since the last guard function execution is reset to zero. In this way, a real-time clock based exponentially decreasing guard function execution algorithm is deployed.

As another time example, the guard can measure the real-time taken for execution of the guard function (guard function execution time), and the real-time duration until the next invocation of the guard (inter-guard execution duration time). If, on guard invocation, the ratio between guard function execution time and inter-guard execution duration time is smaller than some ratio threshold value, then the guard function is executed and the inter-guard execution duration time is reset, otherwise the guard continues to measure the inter-guard execution duration time. Optionally, the ratio threshold value can be increased by some fixed or varying amount after each guard function execution.

The advantages of guard function execution back-off or adjustment algorithms can be multi-fold. First, the problem of automated guard injection into application software can be greatly simplified. Dynamic run-time profile data, while valuable, is not required to manage the performance impact of the inserted guards. When dynamic run-time profile data is utilized for automated guard insertion, there is no guarantee that the later operation of the protected software will be identical to or even similar to the operation when the dynamic run-time profile data was generated. This potential mismatch between the operation of the protected software in the field and the pre-release operation of the protected software for profiling purposes can lead to serious performance issues in the deployed protected software.

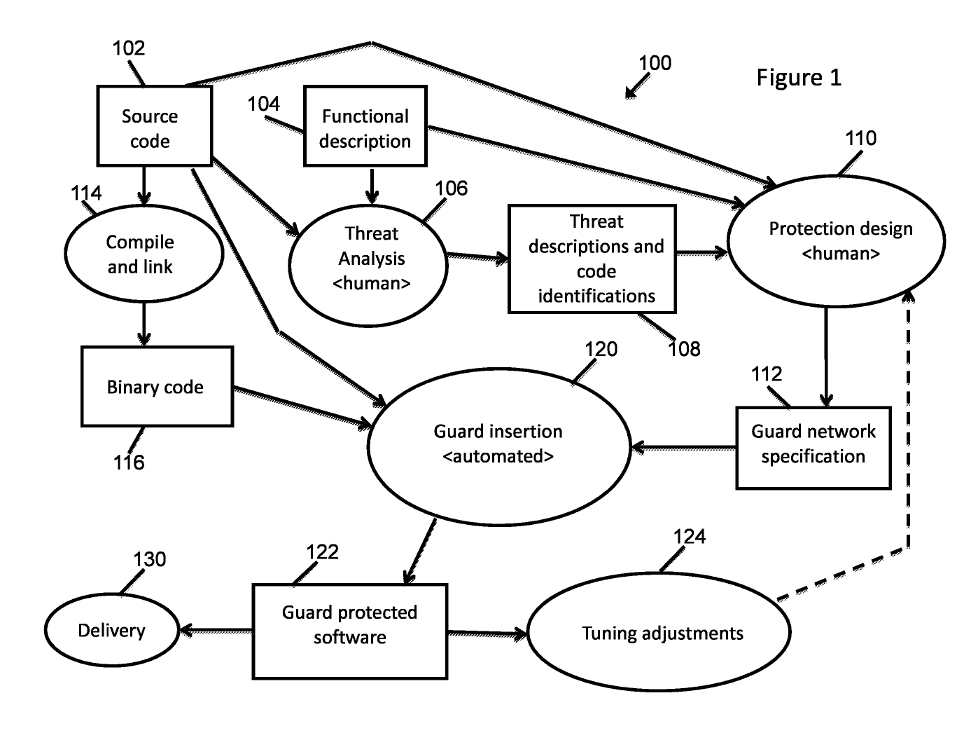

Similarly, the human executed process of guard insertion (such as the process of FIG. 1) is subject to performance risk as well, that can be mitigated with the use of dynamic back-off algorithms controlling guard functional execution.

Self-adjusting guards can greatly reduce or eliminate these issues. Self-adjusting guards can be deployed using various methods for the insertion of the guards themselves, including using current methods in use in production systems and described above. Additionally, new methods for the insertion of self-adjusting guards, in which the guards are inserted without any a priori knowledge of the run-time characteristics of the software to be protected. The dynamic run-time behavioral adjustment of guard function execution is driven by the actual behavior properties of the application software, resulting in an assurance of balance between guard operation (and consequent performance impacts), and the need for guard function execution for anti-tamper and anti-reverse engineering purposes. This allows any number of automated and relatively simple guard insertion methods to be used.

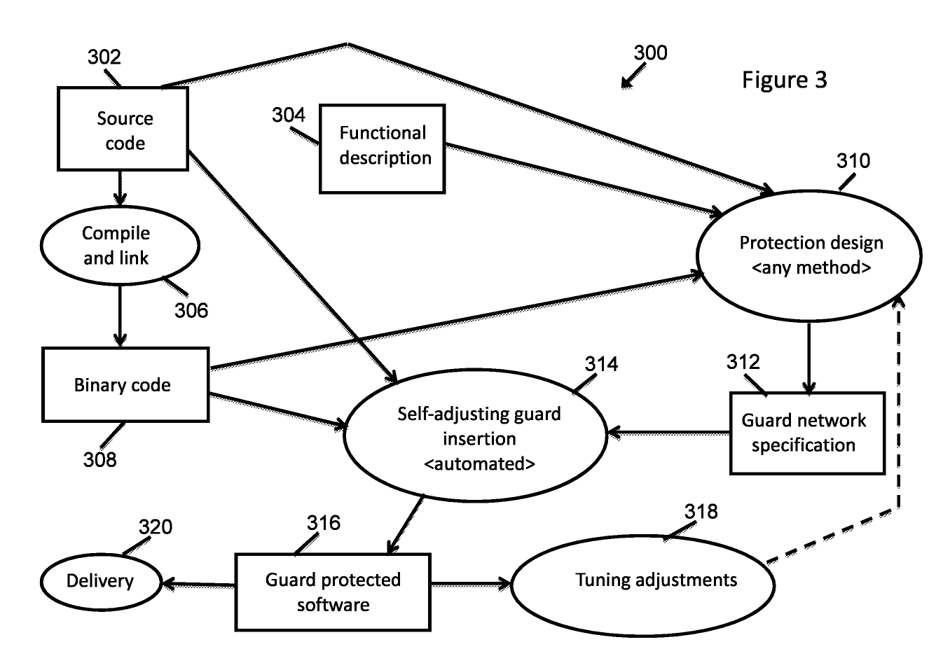

An exemplary guard insertion process for self-adjusting guards is illustrated in the guard insertion process 300 of FIG. 3. The process 300 also starts with software source code 302 and a software functional description 304. The source code 302 goes through a compilation and linking process 306 that produces binary code 308 that can include build artifacts. A protection design process 310 can take the software source code 302, software functional description 304 and/or binary code 308 and produce a guard network specification 312. The protection design process 310 can be performed by any method (manual, automated, etc.) and can include guard network structure, targets and placements. An automated self-adjusting guard insertion process 314 can take the source code 302, binary code 308 and guard network specification 312 to generate guard protected software 316. The guard protected software 316 can be in source or binary form. The guard protected software 316 can go through a tuning process 318 where measurements and tuning are done using guard protection design adjustments. The tuning process 318 can be part of an iterative process to provide further input to the protection design process 310 to revise the guard network specification 312, resulting in a revised self-adjusting guard insertion process 314 generating revised guard protected software 316. The final as well as intermediate guard protected software 316 can be delivered 320.

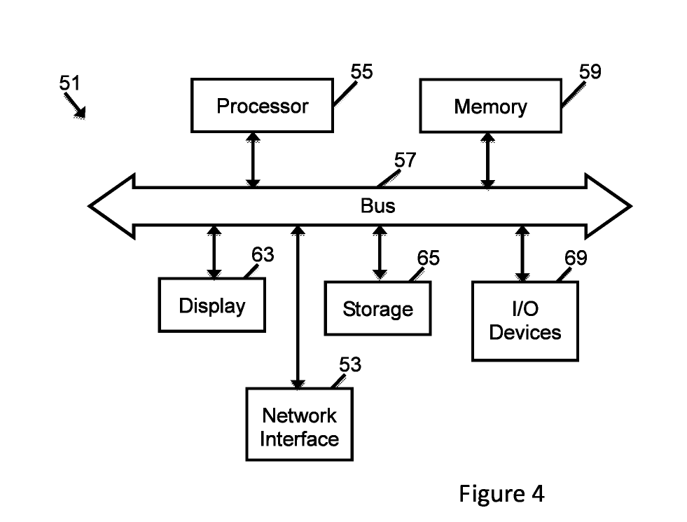

The following description of FIG. 4 is intended to provide an overview of computer hardware and other operating components suitable for performing the methods described above. However, it is not intended to limit the applicable environments. One of skill in the art will immediately appreciate that the invention can be practiced with other computer system configurations, including hand-held devices, multiprocessor systems, microprocessor-based or programmable consumer electronics, networked computer systems, minicomputers, mainframe computers, and the like. The invention can also be practiced in distributed computing environments where tasks are performed by remote processing devices that are linked through a communications network, such as a local area network (LAN), wide-are network (WAN), or over the Internet.

FIG. 4 illustrates an exemplary computer system 51 with interfaces to external systems through the modem or network interface 53. The computer system 51 includes a processor 55 for processing software and data on the computer system 51. A memory 59 that can store software and data is coupled to the processor 55 by a bus 57. The bus 57 couples the processor 55 to the memory 59 and also to non-volatile storage 65 and to display controller(s) and to input/output (I/O) controller(s). The display controller controls a display device 63. The I/O controller can be coupled to one or more input/output devices 69. The input/output devices 69 can include a keyboard, mouse, disk drives, printers, scanners, and other input and output devices. The non-volatile storage 65, an example of a “computer-readable storage medium” and a “machine-readable storage medium”, can be a magnetic disk, an optical disk, a solid-state device or another form of storage for large amounts of data. Information on the non-volatile storage 65 is accessible by the processor 55 and the processor 55 can transfer data to the non-volatile storage 65.

It will be appreciated that the computer system 51 is only one example of many possible computer systems which have different architectures. For example, personal computers based on an Intel microprocessor often have multiple buses, one of which can be an input/output (I/O) bus for the peripherals and one that directly connects the processor 55 and the memory 59 (often referred to as a memory bus). The buses are connected together through bridge components that perform any necessary translation due to differing bus protocols.

It will also be appreciated that the computer system 51 is controlled by operating system software which includes a file management system, such as a disk operating system, which is part of the operating system software. One example of operating system software with its associated file management system software is the Windows family of operating systems from Microsoft Corporation of Redmond, Wash., and their associated file management systems. The file management system is typically stored in the non-volatile storage 65 and causes the processor 55 to execute the various acts required by the operating system to input and output data and to store data in memory, including storing files on the non-volatile storage 65.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains.

We claim:

1. An anti-tamper system for protected software on a computer having a processor and a memory, the anti-tamper system comprising:
a self-adjusting guard inserted in the protected software, the protected software and the self-adjusting guard being stored in the memory of the computer, the self-adjusting guard comprising an invocation criteria and a guard function, the guard function providing some anti-tamper protection for the protected software;
wherein during run-time of the protected software by the processor of the computer, each time the processor invokes the self-adjusting guard, the processor first evaluates the invocation criteria of the self-adjusting guard, and then executes the guard function if the invocation criteria is satisfied and does not execute the guard function if the invocation criteria is not satisfied.

2. The anti-tamper system of claim 1, wherein the invocation criteria of the self-adjusting guard is only satisfied during the Nth time the processor invokes the self-adjusting guard, N being an integer value.

3. The anti-tamper system of claim 1, wherein the invocation criteria of the self-adjusting guard maintains a count of each time the processor invokes the invocation criteria during run-time of the protected software, and the invocation criteria is satisfied during the Mth time the processor invokes the invocation criteria of the self-adjusting guard and every Nth time thereafter, M and N being integer values and M being less than N.

4. The anti-tamper system of claim 1, wherein the invocation criteria of the self-adjusting guard is satisfied randomly with a fixed probability of being satisfied.

5. The anti-tamper system of claim 1, wherein the invocation criteria of the self-adjusting guard maintains a count of each time the processor invokes the invocation criteria during run-time of the protected software, and the invocation criteria is satisfied based on an exponentially decreasing function.

6. The anti-tamper system of claim 1, wherein the invocation criteria of the self-adjusting guard comprises:
a target probability of guard function execution stored in the memory of the computer;
a random or pseudo-random number generator generating a random value in a generation range each time the processor invokes the invocation criteria during run-time of the protected software; and
an invocation range, the invocation range being a subset of the generation range and the probability of the random value being in the invocation range being equal to the target probability of guard function execution;
wherein the invocation criteria is satisfied when the random value is in the invocation range, and upon being satisfied the target probability is decreased and the invocation range is reduced accordingly.

7. The anti-tamper system of claim 1, wherein the invocation criteria of the self-adjusting guard is satisfied based on an elapsed inter-guard invocation time measuring a time duration since that last time the guard function of the self-adjusting guard was executed.

8. The anti-tamper system of claim 7, wherein the invocation criteria of the self-adjusting guard maintains a target inter-guard invocation time indicating the minimum time duration before execution of the guard function, and the guard function is satisfied when the elapsed inter-guard invocation time is greater than the target inter-guard invocation time.

9. The anti-tamper system of claim 8, wherein the target inter-guard invocation time is increased after each execution of the guard function of the self-adjusting guard.

10. The anti-tamper system of claim 7, wherein the invocation criteria of the self-adjusting guard is satisfied based on a guard execution time measuring the time duration for executing the guard function of the self-adjusting guard.

11. The anti-tamper system of claim 10, wherein the invocation criteria of the self-adjusting guard is satisfied when a ratio of the guard execution time to the elapsed inter-guard invocation time is less than a threshold ratio.

12. The anti-tamper system of claim 11, wherein the threshold ratio is decreased after each execution of the guard function of the self-adjusting guard.

13. A method for protecting software on a computer having a processor and a memory, the method comprising:
inserting a self-adjusting guard into the software to generate protected software, the protected software and the self-adjusting guard being stored in the memory of the computer, the self-adjusting guard comprising an invocation criteria and a guard function, the guard function providing some anti-tamper protection for the protected software;
executing the protected software on the computer;
each time the processor of the computer invokes the self-adjusting guard,
evaluating the invocation criteria of the self-adjusting guard,
executing the guard function if the invocation criteria is satisfied, and
not executing the guard function if the invocation criteria is not satisfied.

14. The method of claim 13, wherein evaluating the invocation criteria of the self-adjusting guard comprises:
evaluating the invocation criteria; and
adjusting the invocation criteria if the invocation criteria is satisfied.

15. The method of claim 14, wherein adjusting the invocation criteria comprises updating a target value for satisfying the invocation criteria.

16. The method of claim 15, wherein updating a target value for satisfying the invocation criteria comprises decreasing a probability of satisfaction of the invocation criteria.

17. The method of claim 15, wherein updating a target value for satisfying the invocation criteria comprises computing new minimum time duration until execution of the guard function.

18. The method of claim 14, wherein adjusting the invocation criteria comprises decreasing the likelihood of satisfying the invocation criteria.

19. The method of claim 13, wherein inserting a self-adjusting guard into the software to generate protected software comprises inserting source code for the self-adjusting guard into source code for the software to generate source code for the protected software.

20. The method of claim 13, wherein inserting a self-adjusting guard into the software to generate protected software comprises inserting object code for the self-adjusting guard into object code for the software to generate object code for the protected software.
